(19) United States
(12) Patent Application Publication
(10) Pub. No.: US 2025/0298417 A1
(43) Pub. Date: Sep. 25, 2025

(54) AUTONOMOUS GUIDED VEHICLE SYSTEM

(71) Applicant: Oshkosh Corporation, Oshkosh, WI (US)

(72) Inventor: Devin Rosencrance, Oshkosh, WI (US)

(21) Appl. No.: 19/086,377

(22) Filed: Mar. 21, 2025

Related U.S. Application Data
(60) Provisional application No. 63/568,875, filed on Mar. 22, 2024.

(51) Int. Cl. G05D 1/622; G05D 101/00; G05D 107/70

(52) U.S. Cl. CPC G05D 1/622; G05D 2101/22; G05D 2107/70

(57) ABSTRACT

A method of guiding an autonomous guided vehicle (AGV) includes determine, by one or more processors of the AGV, that a first work operation performed at a first assembly station on a work-in-progress (WIP) piece coupled to the AGV has been completed; responsive to determining that the first work operation has been completed, switching, by the one or more processors, the AGV into an autonomy mode; navigating, by the one or more processors, the AGV to a second assembly station; determining, by the one or more processors, that the AGV has arrived at the second assembly station; adjusting, by the one or more processors, the WIP piece to facilitate a second work operation to be performed at the second assembly station; and switching, by the one or more processors, the AGV from the autonomy mode into a standby mode while the second work operation is performed on the WIP piece.

### CROSS-REFERENCE TO RELATED PATENT APPLICATION

This application claims the benefit of and priority to U.S. Provisional Patent Application No. 63/568,875, filed Mar. 22, 2024, which is incorporated herein by reference in its entirety.

### TECHNICAL FIELD

The present disclosure relates generally to autonomous guided vehicle (AGV) systems such as autonomous mobile robots (AMRs). More specifically, the present disclosure relates to an AGV system for carrying and moving work-in-progress (WIP) pieces through a production assembly at a production facility. The AGV system includes a mobile platform which follows a predefined path indicated by markers or external guidance commands.

### BACKGROUND

Autonomous guided vehicles (AGVs) can be utilized within facilities for a variety of purposes. In some instances, AGVs may be utilized to carry loads between locations within a facility without requiring a human operator to be present. Effectively navigating between locations and properly handling loads autonomously within facilities create a variety of potential issues for the successful operation and deployment of AGVs within facilities.

### SUMMARY

At least one exemplary embodiment relates to a method of guiding an autonomous guided vehicle (AGV). The method includes determining, by one or more processors of the AGV, that a first work operation performed at a first assembly station on a work-in-progress (WIP) piece coupled to the AGV has been completed. The method further includes, responsive to determining that the first work operation has been completed, switching, by the one or more processors, the AGV into an autonomy mode. The method further includes navigating, by the one or more processors, the AGV to a second assembly station. The method further includes determining, by the one or more processors, that the AGV has arrived at the second assembly station. The method further includes adjusting, by the one or more processors, the WIP piece to facilitate a second work operation to be performed at the second assembly station. The method further includes switching, by the one or more processors, the AGV from the autonomy mode into a standby mode while the second work operation is performed on the WIP piece.

Another exemplary embodiment relates to a method of guiding an autonomous guided vehicle (AGV). The method includes navigating, by one or more processors of the AGV, the AGV in an autonomy mode along a path toward a destination. The method further includes detecting, by the one or more processors, an obstacle in the path. The method further includes determining, by the one or more processors, a characteristic of the obstacle. The method further includes performing, by the one or more processors, a response action for responding to the obstacle based at least in part on the characteristic of the obstacle. The method further includes, subsequent to performing the response action, continuing, by the one or more processors, navigation of the AGV to the destination.

An additional exemplary embodiment relates to an autonomous guided vehicle (AGV). The AGV includes a mobile platform configured to carry a work-in-progress (WIP) piece. The AGV further includes a processing circuit having one or more processors coupled to one or more memories having instructions thereon. The instructions, when executed by the one or more processors, cause the one or more processors to navigate the AGV in an autonomy mode along a path toward an assembly station. The instructions, when executed by the one or more processors, further cause the one or more processors to detect an obstacle in the path. The instructions, when executed by the one or more processors, further cause the one or more processors to perform a response action for responding to the obstacle. The instructions, when executed by the one or more processors, further cause the one or more processors to, subsequent to performing the response action, continue navigation of the AGV toward the assembly station. The instructions, when executed by the one or more processors, further cause the one or more processors to determine that the AGV has arrived at the assembly station. The instructions, when executed by the one or more processors, further cause the one or more processors to switch the AGV from the autonomy mode into a standby mode while a work operation is performed on the WIP piece.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a diagram of an autonomous guided vehicle system, according to an exemplary embodiment;

FIG. 2 is a flowchart of a mission profile of the autonomous guided vehicle system of FIG. 1, according to an exemplary embodiment;

FIG. 3 is a diagram of the autonomous guided vehicle system of FIG. 1, according to an exemplary embodiment;

FIG. 4 is a detail view of the diagram of the autonomous guided vehicle system of FIG. 3, according to an exemplary embodiment;

FIG. 5 is a detail view of the diagram of the autonomous guided vehicle system of FIG. 3, according to an exemplary embodiment;

FIG. 6 is a diagram of movement of the autonomous guided vehicle system of FIG. 1, according to an exemplary embodiment;

FIG. 7 is a diagram of operation processes of the autonomous guided vehicle system of FIG. 1, according to an exemplary embodiment;

FIG. 8 is a diagram of operation processes of the autonomous guided vehicle system of FIG. 1, according to an exemplary embodiment;

FIG. 9 is a diagram of operation processes of the autonomous guided vehicle system of FIG. 1, according to an exemplary embodiment;

FIG. 10 is a diagram of operation processes of the autonomous guided vehicle system of FIG. 1, according to an exemplary embodiment;

FIG. 11 is a diagram of operation processes of the autonomous guided vehicle system of FIG. 1, according to an exemplary embodiment;

FIG. 12 is a diagram of operation processes of the autonomous guided vehicle system of FIG. 1, according to an exemplary embodiment;

FIG. 13 is a diagram of operation processes of the autonomous guided vehicle system of FIG. 1, according to an exemplary embodiment;

FIG. 14 is a diagram of operation processes of the autonomous guided vehicle system of FIG. 1, according to an exemplary embodiment;

FIG. 15 is a diagram of operation processes of the autonomous guided vehicle system of FIG. 1, according to an exemplary embodiment;

FIG. 16 is a diagram of operation processes of the autonomous guided vehicle system of FIG. 1, according to an exemplary embodiment;

FIG. 17 is a diagram of operation processes of the autonomous guided vehicle system of FIG. 1, according to an exemplary embodiment;

FIG. 18 is a diagram of operation processes of the autonomous guided vehicle system of FIG. 1, according to an exemplary embodiment; and

FIG. 19 is a diagram of operation processes of the autonomous guided vehicle system of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The present disclosure relates to an autonomous guided vehicle (AGV) system. The AGV system described herein may simplify the integration of such autonomous systems into production facilities by reducing costs and requiring fewer physical modifications to a production facility to define guidepaths. The AGV system described herein also reduces waste and the need for human intervention such as direction to define movement or destination of the WIP pieces. The AGV system can be more flexible with changing production facility layouts or WIP piece designs and can increase productivity and production rates.

### AGV System Overview

Referring generally to the FIGURES, an autonomous guided vehicle (AGV) system 100 includes a ground module 101 (e.g., an AGV). The ground module 101 includes a platform 102, a telematics system 106, and an onboard computing system 107. The AGV system 100 further includes a network of a production facility in communication with the onboard computing system 107 of the ground module 101. The ground module 101 receives operation instructions from the production facility via the network. The operation instructions include one or more of a movement instruction or a navigation instruction.

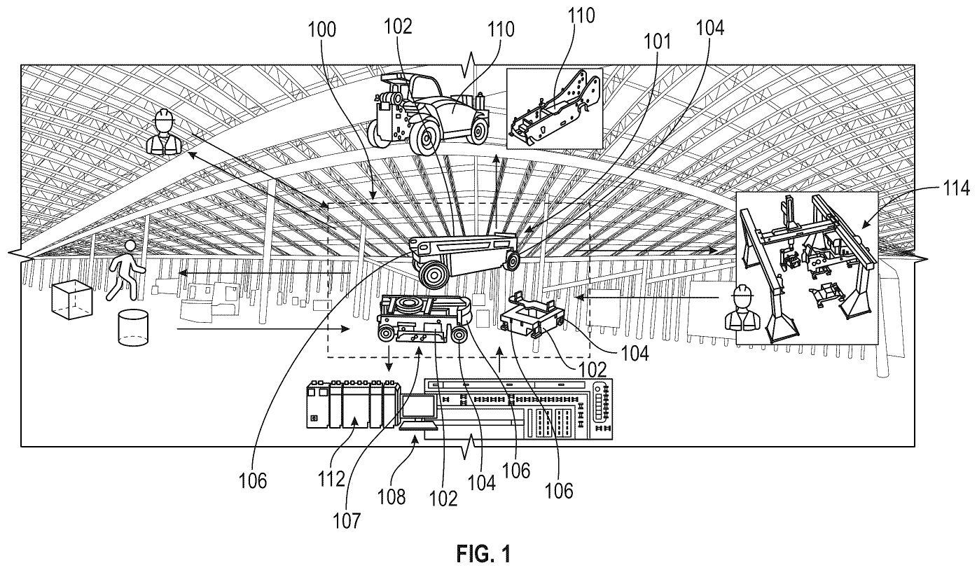

As shown in FIG. 1, the autonomous guided vehicle (AGV) system 100 (e.g., an autonomous mobile robot (AMR), etc.) comprises a mobile vehicle (e.g., the ground module 101) having the platform 102, one or more wheels 104, the telematics system 106 (e.g., one or more cameras, one or more sensors, light detection and ranging (LIDAR), a global positioning system (GPS), etc.), the onboard computing system 107 (e.g., a computer, controllers, a processor and memory, etc.), and one or more onboard batteries. The AGV system may be, for example, an autonomous mobile robot (AMR) (e.g., a Type A Industrial Mobile Robot, an autonomously navigating system with or without a manipulator or robotic arm, an AMR with an attachment, etc.). In some instances, the onboard computing system 107 includes one or more processing circuits having one or more processors coupled to one or more memories having instructions stored thereon that, when executed by the one or more processors cause the processors to perform the various functionalities described herein (e.g., receiving information from other external systems; transmitting information to other external systems; receiving and monitoring senor information from the telematics system 106; controlling the operation of the ground module 101 including the platform 102, the one or more wheels 104, and the telematic system 106; etc.).

The physical build of the ground module 101 of the AGV system 100 is designed to encounter and withstand a number of potential conditions. The AGV system 100 may encounter and withstand moisture, hot and cold temperatures (e.g., 39 degrees F. to 104 degrees F., etc.), vibrations, wind forces, collisions, strikes, etc. Any components of the ground module 101 of the AGV system 100 such as the platform 102, the wheels 104, the telematics system 106, the onboard computing system 107, switches, hoses, cables, hardware, etc. are resistant to damage that may occur during normal use, misuse, or extreme conditions. The ground module 101 of the AGV system 100 is also capable of lifting, carrying, and transporting heavy and/or large loads.

The ground module 101 may be part of a fleet of a plurality of ground modules 101. The AGV system 100 may support and facilitate interaction and communication of the fleet of ground modules 101. Each of the ground modules 101 in the fleet of ground modules 101 may communicate with one another and may be under the control of a fleet manager. In some embodiments, the fleet of ground modules 101 may include one or more skates. A skate may be substantially similar to or the same as any of the ground modules 101 but may operate in an unpowered or follower mode such that the skate is coupled to the ground module 101 and follows the movement of the ground module 101. In other embodiments, the skate may be configured differently and may not have substantially the same characteristics as the ground modules 101. For example, the skate may be a dolly that includes only wheels and a platform for supporting a load.

The ground modules 101 are configured to be transported between facilities. When the ground modules 101 arrive at a facility, the AGV system 100 may be initialized or commissioned to operate within the particular facility. The AGV system 100 may need to be assembled and/or connected to network at the facility.

In general, the AGV system 100 supports and transports work-in-progress (WIP) pieces 110 through a production assembly at a production facility (e.g., a factory, etc.). The WIP piece 110 may be parts, weldments, and assemblies that are being constructed in a production or manufacturing facility that when assembled become a finished product. For example, the WIP piece 110 may be machinery or equipment or portions thereof (e.g., an engine, a cab, a frame, a boom, etc.), parts, a product, etc. that needs to be transported from one location to another location. The WIP piece 110 may need to be transported, for example, from a first stage of assembly in a first location of a production facility to a second stage of assembly in a second location of the production facility. Such locations may be, for example, assembly lines, production lines, installation areas, welding or finishing activities, painting lines, kitting areas, etc. The functions performed by the AGV system 100 can increase productivity by reducing the need for a human to move the WIP piece 110 to various locations (e.g., by driving equipment such as a forklift, etc.).

The AGV system 100 also performs other functions within a production facility, as described further herein. In general, the AGV system 100 may detect a load, a bystander, or an object; lift, move, react to, or communicate with one or more remote systems within the facility regarding a load, a bystander, or an object; perform alignment functions; communicate regarding system functions and maintenance; and/or perform computing or commanding functions. For example, the AGV system 100 may communicate with additional systems 112 (e.g., a manufacturing execution system, an ignition system, a traffic control system, etc.). In some embodiments, the AGV system 100 may receive commands from other systems within the production facility, such as a remote computing system 108. As another example, the AGV system 100 may perform alignment functions with an assembly station 114 to position the ground module 101 in the proper positioning to receive a load. The assembly station 114 may perform detecting functions to detect the ground module 101 and ensure the proper positioning of the ground module 101 to receive the load.

In some embodiments, operators may provide input or communicate with the AGV system 100. For example, an operator may oversee or assist with alignment or detection of the ground module 101 and/or application of the load to the ground module 101. A service technician or system manger may also maintain, manually control, program, or debug the AGV system 100.

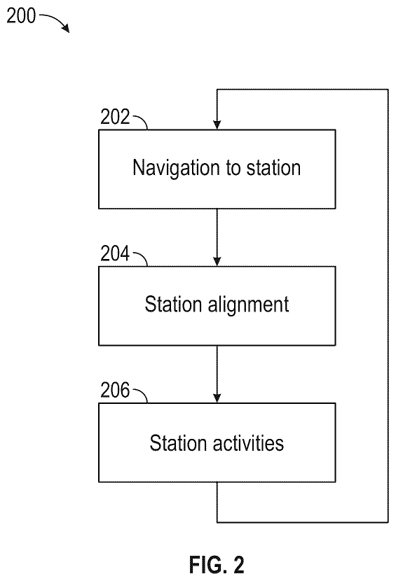

The AGV system 100 includes a mission profile 200, an example of which is depicted in FIG. 2. In general, the mission profile 200 constitutes the operating mission profile of the AGV system 100. The mission profile 200 generally includes three stages of operation for the AGV system 100: navigation to station (e.g., proceeding in a substantially straight direction, performing a turning operation, remaining at a location, etc.), at step 202, station alignment, at step 204, and station activities, at step 206. A station may be an assembly station (e.g., where WIP pieces are assembled, a point on an assembly line, etc.), a charging station, a maintenance station, etc. The AGV system 100 may navigate to the station and perform alignment functions to align the AGV system 100 with the station in a proper location or placement. In some embodiments, alignment may be based on aligning the WIP piece with the station or an element of the station for proper placement of the WIP piece for work to begin on the WIP piece. The AGV system 100 may then perform station activities at the station. For example, the AGV system 100 may navigate to the charging station, perform alignment functions aligning the AGV system 100 with the charging station to ensure proper charging, and then begin charging.

### Systems and Subsystems

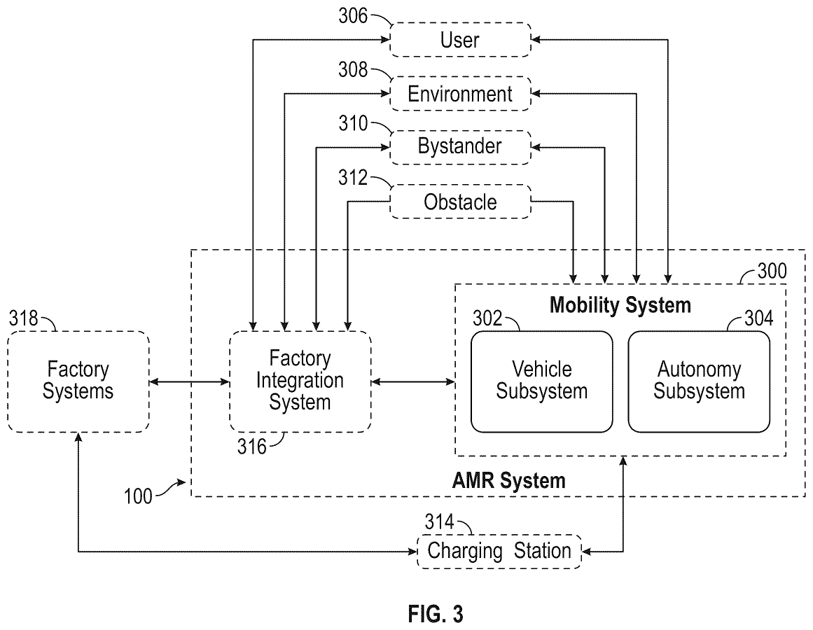

Turning now to FIGS. 3-5, the AGV system 100 includes operating systems, and also communicates and interacts with a number of other systems. The AGV system 100 includes a mobility system 300. In some embodiments, the mobility system 300 is integrated within the ground module 101. The mobility system 300 includes a vehicle subsystem 302 and an autonomy subsystem 304. The mobility system 300, including the vehicle subsystem 302 and the autonomy subsystem 304, may have a computing system, a processor and memory, and/or one or more controllers. The vehicle subsystem 302 controls components of the AGV system 100 (e.g., the ground module 101) such as the frame, steering, driving, lifting, distribution, controls, charging, battery use, etc. The autonomy subsystem 304 controls systems such as an array of autonomy sensors (e.g., visual sensors, auditory sensors, light-based sensors, radar sensors, LIDAR sensors, temperature sensors, humidity sensors, electrical sensors, etc.), a computing unit (e.g., a computer, a controller, etc.), and autonomy software (e.g., of the ground module 101 and in communication with the onboard computing system 107). As shown in FIG. 3, the mobility system 300 communicates information to and from a user 306, an environment 308, a bystander 310, an obstacle 312, a charging station 314, etc. For example, the mobility system 300 may communicate information to and from these various entities and/or components via various inputs and/or outputs (e.g., sensors, audio outputs, video outputs, keyboards, joysticks, steering wheels) associated with the mobility system 300.

The AGV system 100 may also include, or be in communication with, a factory integration system 316. The factory integration system 316 may include a computing system, a processor and memory, and/or one or more controllers. The factory integration system 316 controls a master control panel, secondary guidance, safety sensors, antenna, etc. The factory integration system 316 also provides an interface between a production facility system 318 (e.g., factory system, etc.), automation systems, and the AGV system 100 (e.g., the AMR system, etc.). As shown in FIG. 3, the factory integration system 316 communicates information to and from the mobility system 300, the production facility system 318, the user 306, the environment 308, the bystander 310, the obstacle 312, etc. The production facility system 318 may also be in communication with the charging station 314. However, the production facility system 318 may not be in direct communication with the mobility system 300 or may not be capable of communicating with the mobility system 300, but instead may use the factory integration system 316 to facilitate communication.

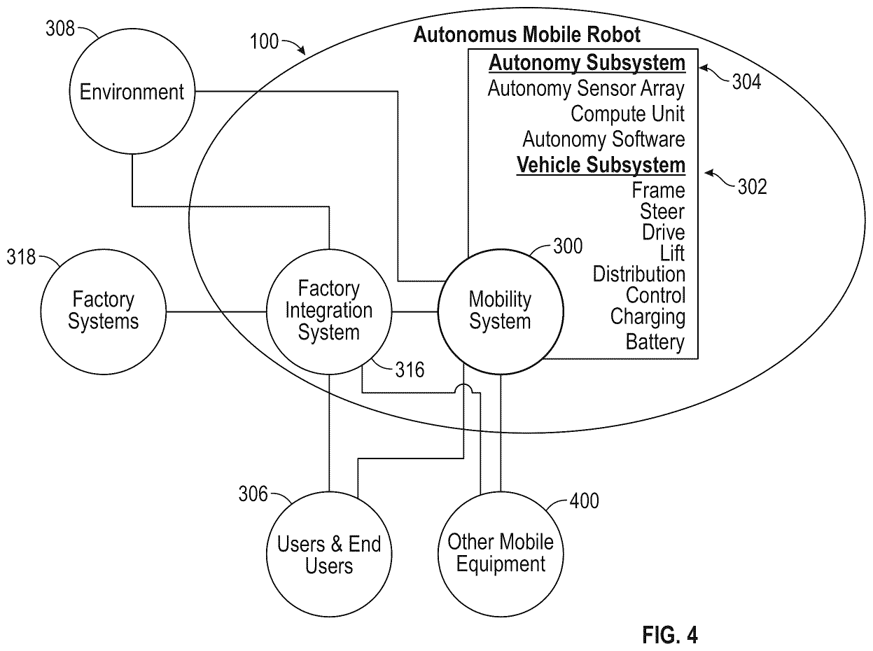

As further shown in FIG. 4, the user 306 and the environment 308 may be in communication with (e.g., via the various inputs/outputs referenced above) the mobility system 300 and/or the factory integration system 316 regarding any number of issues or occurrences. The mobility system 300, the factory integration system 316, and the user 306 may communicate regarding, for example, operation, service or maintenance, transportation, storage, abuse cases, malicious intent, bystanders, workers, site visitors, etc. The environment 308 may be in communication with the mobility system 300 and/or the factory integration system 316 regarding, for example, ground-based obstacles, elevated obstacles, electromagnetic ground debris, airborne particulates, floor abnormalities, etc.

The environment 308 of the AGV system 100 may experience a wide variation of features and occurrences. A floor of the environment 308 may have such features as old paint lines, tape, numbers, stray marks, grout in floor segments, bore holes, unpainted sections, oil-dri material, water puddles, oil spills, floor debris (e.g., pieces of hardware, packaging materials, etc.), electromagnetic ground debris, screens on various surfaces (e.g., weld screens, mesh screens, etc.), floor abnormalities, etc. The environment 308 also may include features positioned at a distance from the floor, such as elevated mirrors at intersections, caution tape roping off certain areas, traffic cones or tall cylinder cones, airborne particulates, etc. Various types of obstacles may be present in the environment 308 such as ground-based obstacles, elevated obstacles, and/or moving obstacles. The lighting in the environment 308 may be variable in different areas of the production facility. For example, the environment 308 may have fluorescent overhead lighting, colored directional lights, flashing lights, strobe lights, amber lights, white lights, headlights on vehicles, unshielded welding arcs, etc. The environment 308 also may experience different noise levels. In general, a typical ambient sound limit for a production facility is approximately 85 dB. The AVG system 100 is configured to navigate any such feature or occurrence in the environment 308.

The production facility system 318 (e.g., factory system, etc.) may also communicate with the factory integration system 316 regarding any number of issues, occurrences, or other operational items, such as, for example, assembly stations, robotic cells, ignition supervisory control and data acquisition (SCADA), traffic control, supervisory actions, etc. Additionally shown in FIG. 4, the mobility system 300 and/or the user 306 may be in communication with other mobile equipment 400 regarding the AGV system 100, fork trucks, bridge cranes, completed machines, assembly stations, robotic manipulators, etc.

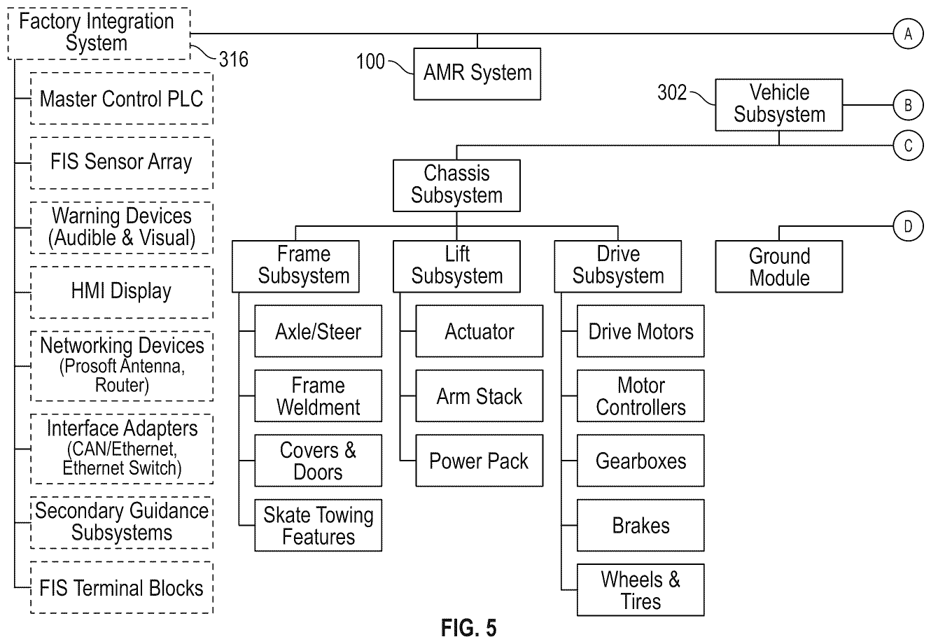

FIG. 5 depicts further systems which may be included in or in communication with the AGV system 100. The vehicle subsystem 302 can include a chassis subsystem and a control subsystem. The chassis subsystem may further include frame, lift, and drive subsystems. Within the frame subsystem, other systems relating to axles, steering, frame weldment, covers and doors, and/or skate towing features, etc. may be included. The lift subsystem may include actuator, arm stack, and/or power pack systems, etc. The drive subsystem may include drive motor, motor controller, gearbox, brake, wheel, and/or tire systems etc.

The control subsystem further includes a ground module subsystem, a vehicle user interface subsystem, a distribution subsystem, a battery subsystem, and/or a charging subsystem, etc. The vehicle user interface subsystem may include systems relating to e-stops and/or wireless or wired manual control, etc. The distribution subsystem may include fuse, harness, main disconnect, and/or mobility system buses systems, etc. Additionally, the charging subsystem can include wireless or secondary charging systems, etc. The autonomy subsystem 304 of the mobility system 300 includes an autonomy compute unit system and an autonomy sensor array system. The autonomy compute unit system has a compute unit and software. The autonomy subsystem 304 may communicate with an autonomy server to host and share data for and to the autonomy subsystem 304.

The factory integration system 316 may be in communication with further systems including a master control programmable logic controller (PLC), sensor arrays (e.g., flexible inspection system (FIS) sensor arrays), audio and visual warning devices, human-machine interface (HMI) displays, networking devices (e.g., antenna, router, etc.), interface adapters (e.g., controller area network (CAN), ethernet, etc.), secondary guidance systems, and/or FIS terminal blocks, etc.

Certain connections may be necessary to enable communication between the various systems and subsystems of the AGV system 100. The control subsystem of the vehicle subsystem 302 of the mobility system 300, for example, may include connections to the factory integration system 316 such as a push button start, an emergency stop (e.g., a protective stop, etc.), mode communication, a CAN network, direct current (DC) power to supply power to the factory integration subsystem 316 components, and parameters and feedback information from the battery charger. In the event that the AGV system 100 battery has shut down due to inactivity, a button (e.g., the push button start, etc.) may be used to wake the system from this state. Connections may communicate actuation of the emergency stop to a master control PLC. The master control PLC will have control over the operating mode of the AGV system 100 and will communicate a state of condition of the AGV system 100. The CAN network may communicate data from the vehicle subsystem 302. The data may be motor encoder data (e.g., odometry, etc.), component status data (e.g., the motors, etc.), battery voltage and amperage, state of charge of the battery, alarm messages, active fault codes, requests for the master control PLC to enter or leave a manual mode, etc.

Additionally, the control subsystem of the vehicle subsystem 302 of the mobility system 300 may include connections to the autonomy subsystem 304 of the mobility system 300. A CAN network may be needed for communication and control of systems and data such as heartbeat, angular motion requests, linear motion requests, system status, autonomy compute unit (ACU) status, application status, fault codes, personality data (e.g., maximum speed or maximum turning radius of the AGV system 100, etc.), motion feedback (e.g., encoder data, steer angle, etc.), system mode, etc. DC power connections may also be needed to supply power to the components of the autonomy subsystem 304.

The autonomy subsystem 304 of the mobility system 300 may include certain connections to the factory integration system 316, such as a CAN network. The CAN network provides communication, notifications, and controls relating to systems and data. Such systems and data may include heartbeat, system status, ACU status, application status, localization status, localization confidence, fault codes, object detection status, waypoint arrival confirmation, destination arrival confirmation, periodic navigation status, motion intent command, master control PLC heartbeat, motion interlocks (e.g., start motion, continue motion, pause motion, stop motion, etc.), route transmission, destination commands from the master control PLC, etc.

### Operating Modes and Operational Processes

The AGV system 100 may have various system states and modes. For example, the AGV system 100 may have an Autonomy Mode, a Guided Mode (e.g., semi-automatic mode, etc.), a standby mode, a manual mode, a collision avoidance mode, a maintenance mode, an emergency stop mode (e.g., when an emergency stop button has been depressed), and/or a main disconnect switch off mode, etc. In Autonomy Mode, all functions of the AGV system 100 are directed by and under the control of programmed logic (e.g., artificial intelligence systems, computer coding, etc.), and the AGV system 100 will respond to drive and steer commands from the ACU. The AGV system 100 can enter Autonomy Mode upon receiving a command issued by a supervisory PLC through the master control PLC. When adverse conditions are detected by the master control PLC, stop commands will be issued. The stop commands will have priority over the ACU over other functions or modes. For example, in Autonomy Mode, the AGV system 100 may be able to drive and steer, but lifting functions may be disabled based on a received stop command associated with the lifting functionality of the AGV system 100.

In Guided Mode, the AGV system 100 can be controlled by the master control PLC. Lift, drive, and steer commands will be issued to the AGV system 100. Guided Mode operation may leverage sensing systems that are both part of the factory integration system 316 and/or external to the ground module 101 of the AGV system 100. In Guided Mode, the ACU is inactive or in standby mode.

The AGV system 100 will be in standby mode when parked or docked at assembly stations, when charging at charging stations, when an onboard wired charger is plugged in, and during periods where production is not active. In standby mode, any peripheral system in the factory integration system 316 that is powered, including safety scanners, will be turned off. The ground module 101 of the AGV system 100 and the ACU will remain on, but can enter a low power mode.

Manual operation of the AGV system 100 can be performed when the AGV system 100 is in manual mode. Manual mode is engaged when the AGV system 100 is connected to an operator controller, pendant (e.g., a wired or wireless pendant, a portable control unit such as a joystick, etc.), or control panel. In some instances, the ground module 101 may not be equipped with a switch or button to select manual mode, instead manual mode can be accessed either from an automatic or manually actuated request from the operator controller, the pendant, or the control panel that is connected to the master control PLC. The master control PLC may provide a pendant status message on a SCADA CAN network. Removal of the operator controller, the pendant, or the control panel may signal the master control PLC to place the AGV system 100 into standby mode. The operator will have control of all of the functions of the AGV system 100 including lift, drive, and steer. Personnel detection will be inactive during manual mode and the operator will be responsible for the safe operation of the AGV system 100. In manual mode, sensors and reactions to objects may be disabled by the master control PLC or the factory integration system 316, placing responsibility for the safe operation of the AGV system 100 with the operator. When the AGV system 100 is operating in manual mode, the master control PLC and the factory integration system 316 may be responsible for communicating the system state of the AGV system 100 visibly and audibly per regulatory standards and production facility precedent, except when the master control PLC may be unresponsive and/or a physical jumper is used. Some forms of manual operation may be disabled or limited. For example, in some instances, manual lift functionality may only be available through entering a more advanced level of manual control or manual mode, or only available to more advanced operators.

In maintenance mode, trained service technicians may have the capability to override sensors and adjust personalities, enabling calibration of the sensors and commissioning. The functions available would be similar to those of other equipment or machinery (e.g., scissor lifts, etc.) in a service mode. To access service mode, a log-in with a password may be required.

If the master control PLC is inoperable and the system needs to be manually operated in maintenance mode or recovery mode, a physical jumper may bridge the master control PLC and the ground module 101 and force entrance into manual mode. In some embodiments, the jumper may replace a master control PLC plug and may be physically tethered to the master control PLC and the ground module 101.

In collision avoidance mode, a predetermined action may be taken by the AGV system 100 to prevent a collision or to reduce the severity of a collision when an obstacle cannot be avoided. For example, the AGV system 100 may perform automatic stopping, braking, or decelerating functions in collision avoidance mode (e.g., based on detected potential collisions.

When the emergency stop is depressed, activating the emergency stop mode, the AGV system 100 ceases any active operation. For example, in some instances, the brakes may be automatically applied upon loss of drive power to the AGV system 100. Accordingly, in some instances, the control systems of the AGV system 100 may temporarily continue to receive power to properly shut down and send state communications to the production facility system 318.

In main disconnect switch off mode, a main disconnect switch is set to its ‘off’ position and no power is provided to any systems of the AGV system 100. The main disconnect switch is lockable to prevent unauthorized use of or tampering with the AGV system 100. In any of the system states and modes, it may be necessary to move the ground module 101 of the AGV system 100 either by lifting or towing if the ground module 101 becomes unresponsive or unable to drive. For example, if the ground module 101 of the AGV system 100 is to be towed, the automatically applied brakes may be released.

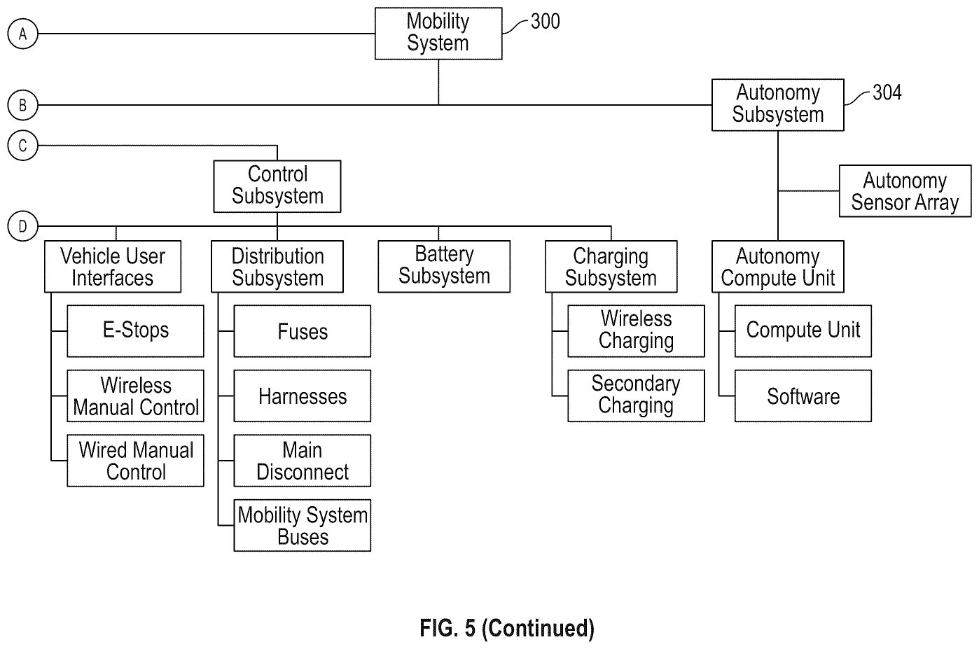

As shown in FIG. 6, the AGV system 100 may automatically travel and navigate from location to location via a path 600 (e.g., a guidepath, a path through a working space to avoid obstacles, etc.). The path 600 may be a curved path or a straight path, or take any other shape or direction. The AGV system 100 may perform different types of operational processes. For example, the AGV system 100 may have a production line operation mode (e.g., main line or subassembly line unit modes, etc.) and an off-line operation mode. During production line operation, for example, the ground module 101 of the AGV system 100 may not navigate around obstacles encountered on the path 600. Instead, the AGV system 100 may stop and temporarily wait for the obstacle to be removed from the production line path. During off-line mode, the ground module 101 may navigate around obstacles encountered on the path 600.

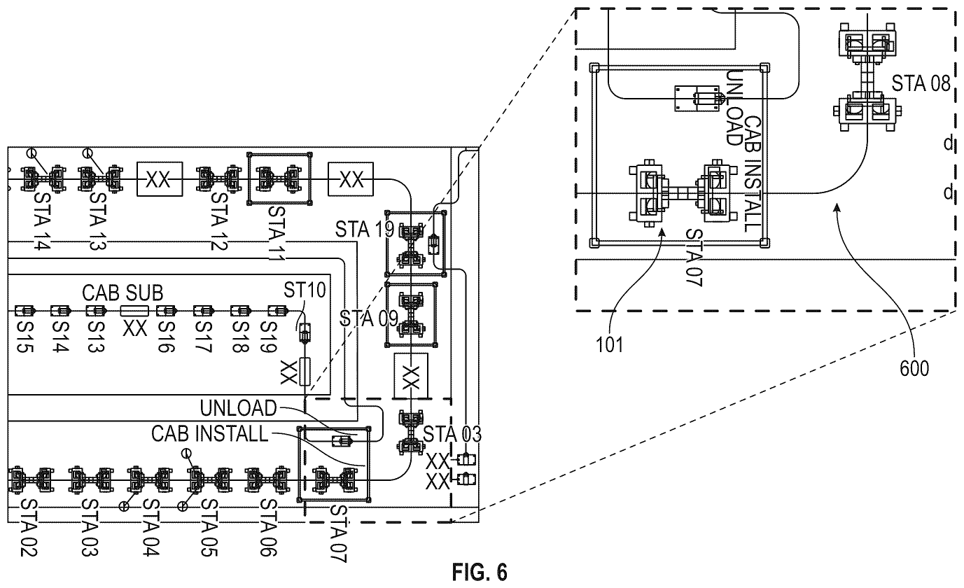

FIGS. 7-19 show various operational processes and methods of the AGV system 100. Referring first to FIG. 7, at a start step 702, the AGV system 100 may be in standby mode until work at an assembly station is completed and a supervisory control system is ready to command motion of the AGV system 100. At this time, the supervisory control system may issue a command to the master control PLC enabling the AGV system 100 to move.

The master control PLC and the factory integration system 316 are responsible for communicating the impending motion visibly and audibly per regulatory standards and production facility precedent. During Autonomy Mode initialization, at step 704, the master control PLC switches the AGV system 100 into Autonomy Mode and sends a destination target to the ACU via a message on the SCADA CAN network. The message provides the destination target to the ground module 101 of the AGV system 100. The ACU may store details relating to destinations and waypoints on a memory.

During autonomous navigation, at step 706, the ACU issues drive, speed, and steer angle requests to the ground module 101 via messages on the SCADA CAN network. When the AGV system 100 is in motion, the master control PLC and the factory integration system 316 are responsible for communicating the system state visibly and audibly per regulatory standards and production facility precedent.

In some instances, various waypoints and destinations may be marked within the facility via corresponding virtual pucks or other identifiers to allow for autonomous navigation. That is, the ACU may navigate the ground module 101 sequentially to several waypoints marked by corresponding virtual pucks until the ground module 101 arrives at an intended destination marked by a corresponding virtual puck. Upon arriving at each virtual puck, at step 708, the ACU may determine whether the ground module 101 has arrived at a waypoint or the final destination target. Upon arrival at a waypoint, the ACU will not stop nor wait for additional direction. The ACU will instead continue motion of the AGV system 100 onto the next waypoint on the path to the destination target. Additionally, when the AGV system 100 has arrived at a waypoint, the ACU will communicate via a message on the SCADA CAN network to the master control PLC that the AGV system 100 has reached the waypoint, at step 710.

When the AGV system 100 has arrived at the destination target, at step 712, the ACU will communicate via a message on the SCADA CAN network to the master control PLC that the AGV system 100 has completed an objective. Upon completion of the objective (e.g., arrival at a station, placement of the WIP piece 110 at a station, etc.), the master control PLC will place the AGV system 100 in standby mode, at step 714. At this time, station activities for the respective station will commence, at step 716.

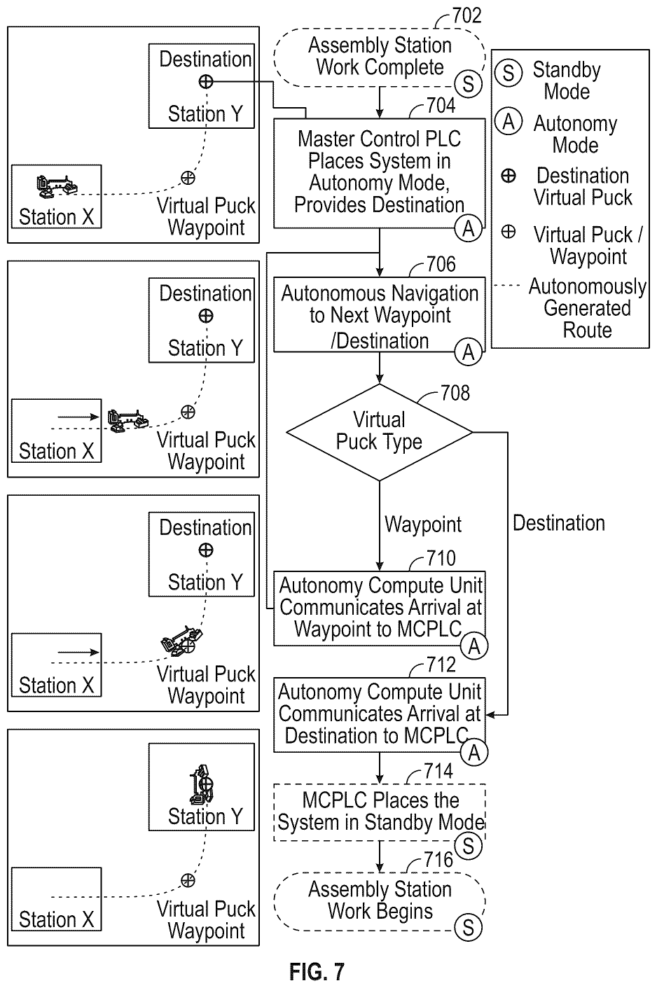

As shown in FIG. 8, at step 802, the AGV system determines if the station necessitates vertical motion (e.g., lifting of a load, etc.) or another type of adjustment (e.g., tilting, rotating, advancing or retracting, etc.) of the WIP piece 110 to facilitate an operation to be performed at the station. For example, in some instances, the station may only be configured to receive or perform a work operation on the WIP piece 110 in a specific orientation or at a specific height. If the station necessitates vertical motion, the master control PLC will first place the system in Guided Mode at step 804. The master control PLC will then issue a target height via a message on the SCADA CAN network as a command to the ground module 101 at step 806. The AGV system 100 controls the lift function of the ground module 101 via one of the vehicle subsystems 302 configured to lift the WIP piece 110 until the target height is reached. In some instances, the AGV 100 may similarly adjusts the WIP piece 110 in another manner (e.g., tilt, rotate, advance, retract) using a corresponding vehicle subsystem 302 to align the WIP piece 110 to be received by and/or worked on at the assembly station. The station operators may be responsible for verifying overhead clearance during lift functions. The master control PLC and factory integration system 316 may be responsible for communicating impending and active motion visibly and audibly per regulatory standards and the production facility precedent. After the vertical motion is completed, or if no vertical motion is required, the master control PLC places the system in standby mode at step 808. At this time, station activities for the respective station will commence, at step 810.

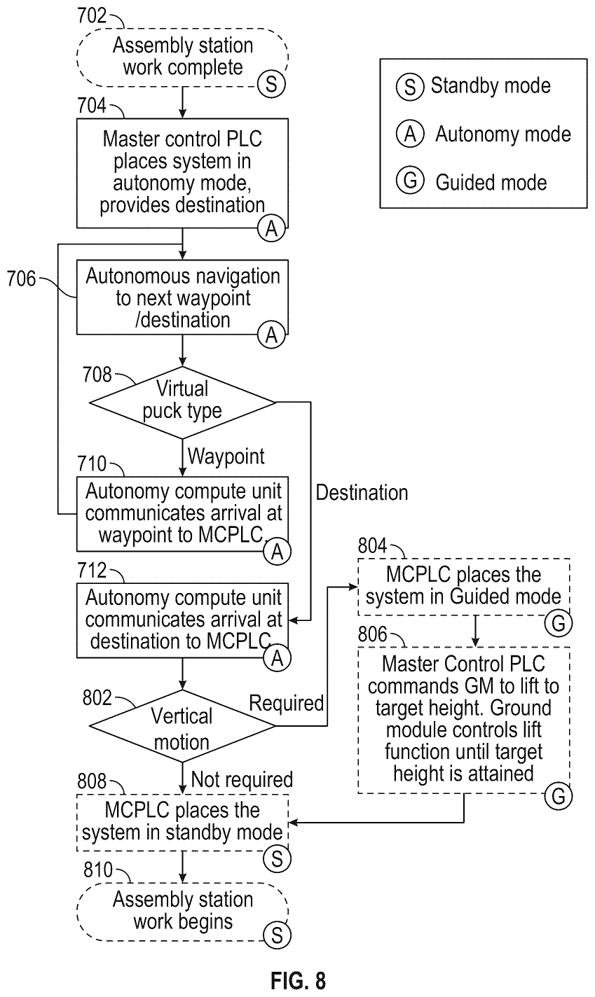

As shown in FIGS. 9-16 the start step may begin at a point where an object enters the path 600 of the AGV system 100 at step 902. The object can include a pedestrian, other mobile equipment, or an obstacle. The height of the object and the distance at which it enters the field of view of the AGV system 100 may affect which components of the telematics system 106 (e.g., sensors, cameras, LIDAR, GPS system, etc.) first detect the object. Once the ACU detects the object in the path 600 of the AGV system 100, the ACU will communicate the detection of the object to the master control PLC via message on the SCADA CAN network at step 904, and the ACU will pause the navigation process and bring the AGV system 100 to a stop. The master control PLC and factory integration system 316 may be responsible for communicating the stop visibly and audibly per regulatory standards and production facility precedent. The AGV system 100 may remain in Autonomy Mode for a configurable time period (e.g., measured, for example, by a timer) or until the object is removed from the path 600 at step 906, whichever occurs first. Distances for determining an object is in the path 600 may be defined by operators or users. In the event that the object is detected by both the LIDAR and the autonomy system 304, the master control PLC may have priority over the autonomy system 304.

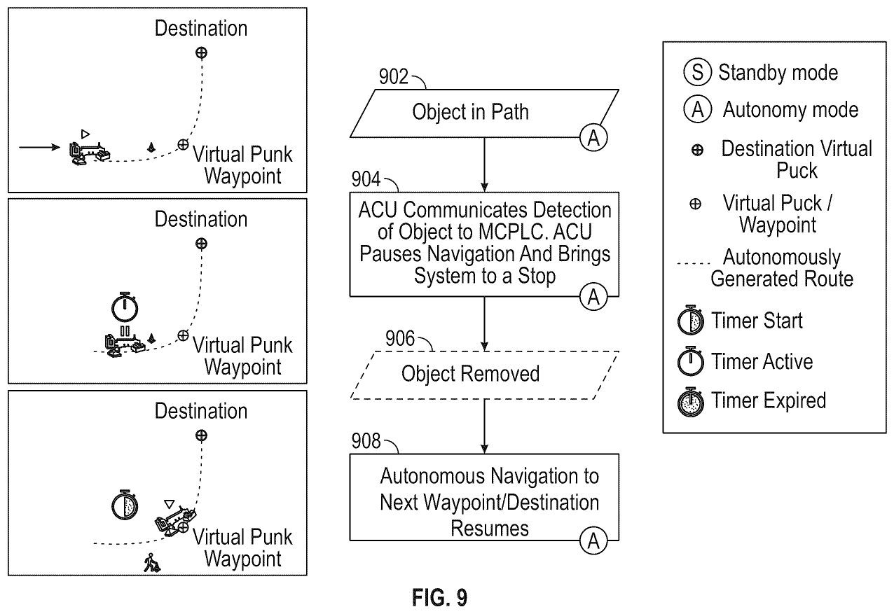

If the object is removed from the path 600 in less than the configurable time period, either by its own locomotion or through manual intervention, the autonomy system 304 may be free to resume motion at step 908. The ACU will communicate the intent to resume motion via a message on the SCADA CAN network. If the AGV system 100 has been stopped for more than a period (e.g., 10 seconds, etc.), the master control PLC and factory integration system 316 may be responsible for communicating the impending motion visibly and audibly per regulatory standards and production facility precedent. The ACU will communicate the resumption of motion via a message on the SCADA CAN network, but the ACU may wait for the master control PLC to confirm that the impending motion notifications have been issued. If the object is not removed from the path 600 within the configurable time period, for example, as shown in FIG. 10, the master control PLC may place the AGV system 100 in standby mode, at step 1002.

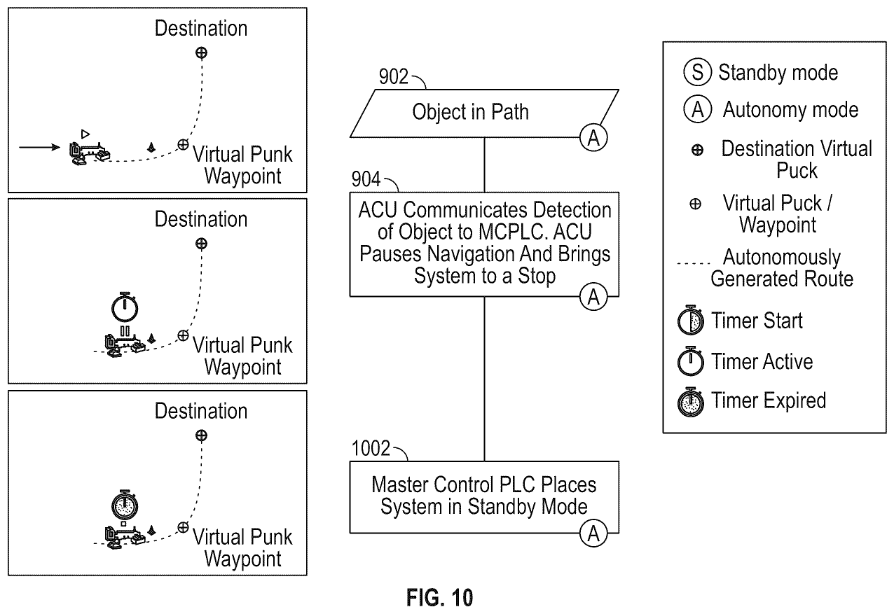

Turning now to FIG. 11, in the event that the factory integration system 316 detects an obstacle in the path 600 of the unit (e.g., by the use of scanners, sensors, etc.) at step 1102, the master control PLC may place the AGV system 100 into standby mode at step 1104. The master control PLC may bring the AGV system 100 to a stop through commands sent to the ground module 101. The master control PLC may also send a hold command to the ACU to end any ACU processes. The master control PLC and the factory integration system 316 may be responsible for communicating the stop visibly and audibly per regulatory standards and production facility precedent. Distances for determining an object is in the path 600 for issuing stop commands may be defined by operators or users. When the object has been removed from the path 600, the master control PLC, may confer with a supervisory PLC and a traffic control PLC, and will communicate the impending motion visibly and audibly per regulatory standards and production facility precedent. The master control PLC switches the AGV system 100 into Autonomy Mode and sends a destination target to the ACU via a message on the SCADA CAN network at step 1106. At step 1108, autonomous navigation to the next waypoint or destination resumes.

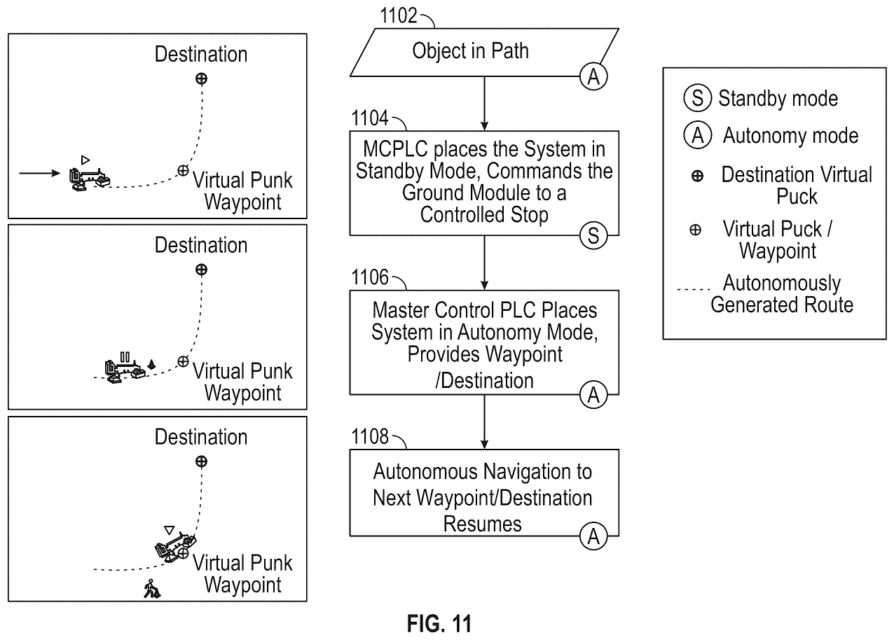

FIGS. 12-17 depict the off-line mode of the AGV system 100. The off-line mode of the AGV system 100 may include ground modules 101 operating outside of production lines to perform functions like delivering kits or delivering weldments to the paint line. During the off-line mode, the start step may begin at a point where an object enters the path 600 of the AGV system 100 at step 1202. The object can include a pedestrian, other mobile equipment, or an obstacle. The height of the object and the distance at which it enters the field of view of the AGV system 100 may affect which components of the telematics system 106 (e.g., sensors, cameras, LIDAR, GPS system, etc.) first detect the object at step 1204. In the event that the object is detected by both the LIDAR and the autonomy system 304, the master control PLC may have priority over the autonomy system 304. Once the ACU detects the object in the path 600 of the AGV system 100, the ACU will plot a route around the object. After plotting the route around the object, the ACU will resume navigation to the next waypoint. If the ACU is unable to establish a route around the object, the ACU will communicate the detection of the object to the master control PLC via message on the SCADA CAN network at step 1206. The ACU will pause the navigation process and bring the AGV system 100 to a stop. The master control PLC and factory integration system 316 may be responsible for communicating the stop visibly and audibly per regulatory standards and production facility precedent. The AGV system 100 may remain in Autonomy Mode for a configurable period or until the object is removed from the path 600, whichever occurs first. Distances for determining an object is in the path 600 may be defined by operators or users.

If the object is removed from the path 600 in less than the configurable period at step 1208, either by its own locomotion or through manual intervention, the autonomy system 304 may be free to resume motion at step 1210. The ACU will communicate the intent to resume motion via a message on the SCADA CAN network. If the AGV system 100 has been stopped for more than a period (e.g., 10 seconds, etc.), the master control PLC and factory integration system 316 may be responsible for communicating the impending motion visibly and audibly per regulatory standards and production facility precedent. The ACU will communicate the resumption of motion via a message on the SCADA CAN network, but the ACU may wait for the master control PLC to confirm that the impending motion notifications have been issued. If the object is not removed from the path 600 within the configurable period, the master control PLC may place the AGV system 100 in standby mode at step 1212. When the object is removed at step 1214, movement of the AGV system 100 may resume at step 1216.

In the event that the LIDAR detects the obstacle in the path 600 of the AGV system 100, or the object is detected by both the ACU and the master control PLC, the master control PLC may place the system into standby mode and bring the system to a stop through commands to the ground module 101 at step 1218. The master control PLC may also send a hold command to the ACU to end any ACU processes. The master control PLC and factory integration system 316 may be responsible for communicating the stop visibly and audibly per regulatory standards and production facility precedent. Distances for determining an object is in the path 600 for issuing stop commands may be defined by operators or users.

When the object has been removed from the path 600 at step 1214, the master control PLC, may confer with a supervisory PLC and a traffic control PLC, and will communicate the impending motion visibly and audibly per regulatory standards and production facility precedent. The master control PLC switches the AGV system 100 into Autonomy Mode and sends a destination target to the ACU via a message on the SCADA CAN network at step 1216.

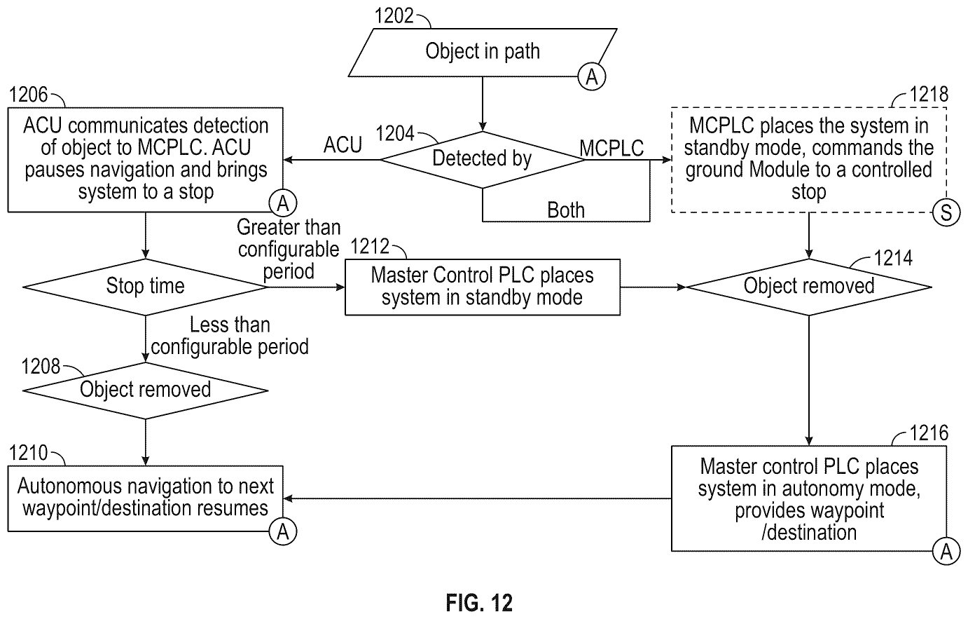

As shown in FIG. 13, the start step may begin at a point where an object enters the path 600 of the AGV system 100 at step 1302. The object can include a pedestrian, other mobile equipment, or an obstacle. Dependent upon what type of object enters the path 600 of the AGV system 100, the AGV system 100 may perform different functions. The AGV system 100 may determine certain characteristics of the object (e.g., size, shape, a movement state, whether it is a person or an inanimate object, etc.). For example, if the object is large, heavy, stationary or not easily movable, etc., the AGV system 100 may determine that a route should be plotted around the object rather than wait for the object to move or be moved. Once the ACU detects the object in the path 600 of the AGV system 100, the ACU may plot a route around the object and attempt navigation around the object at step 1304. After successfully navigating around the object, the ACU may resume navigation to the next waypoint or destination at step 1306.

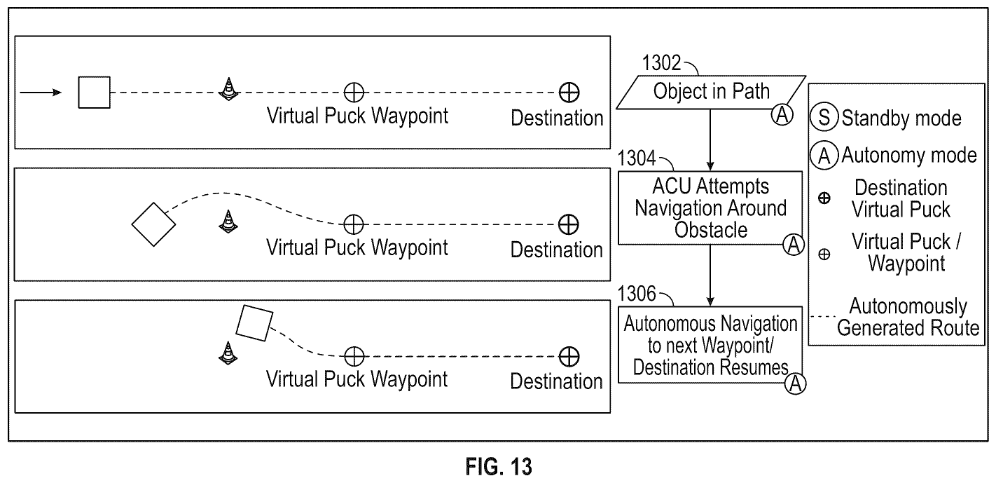

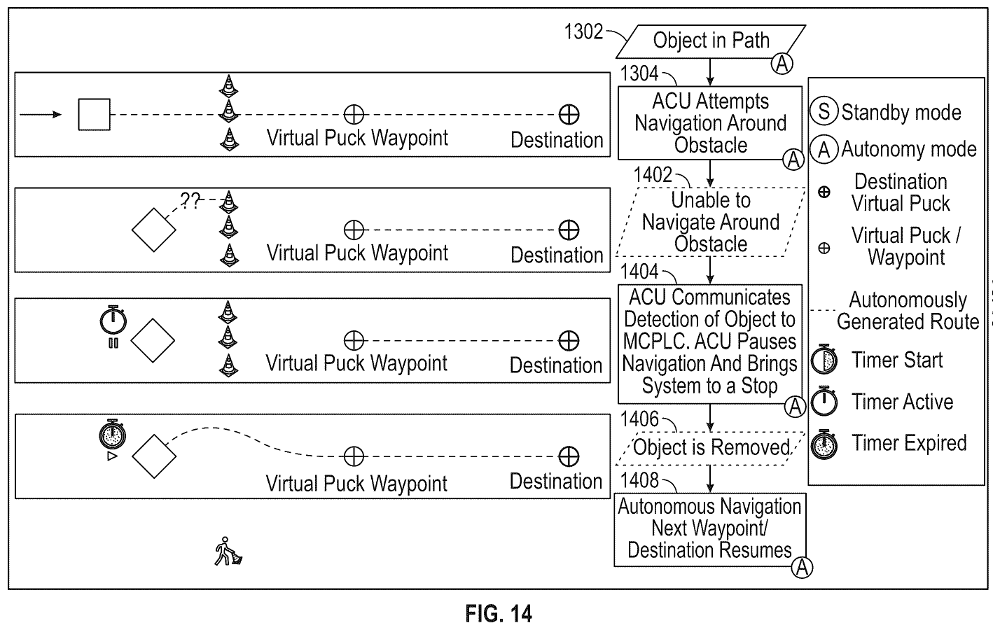

In the event that an object is sufficiently blocking (e.g., based on the object's size) a waypoint such that the ACU is neither able to navigate close enough to establish arrival at the waypoint nor is able to navigate to an area where the ACU can establish arrival at a waypoint, the ACU may be unable to establish a route around the object at step 1402 as shown in FIGS. 14 and 15. The ACU will communicate detection of the object to the master control PLC via a message on the SCADA CAN network, pause the navigation process, and bring the AGV system 100 to a stop at step 1404. The master control PLC and factory integration system 316 may be responsible for communicating the stop visibly and audibly per regulatory standards and production facility precedent. The AGV system 100 may remain in Autonomy Mode for a configurable period or until the object is removed from the path 600 at step 1406, whichever occurs first. Distances for determining an object is in the path 600 may be defined by operators or users.

If any emergency stop devices (e.g., devices which automatically and rapidly stop propulsion, prohibit automatic restart, stop moving components, apply emergency braking, etc.) are reset or any systems within the AGV system 100 are repowered, the master control PLC may place the AGV system 100 in standby mode at step 1408. The mobility system 300 (e.g., the autonomy system 304 and the ground module 101, etc.) will not resume previous activity without direction from the master control PLC.

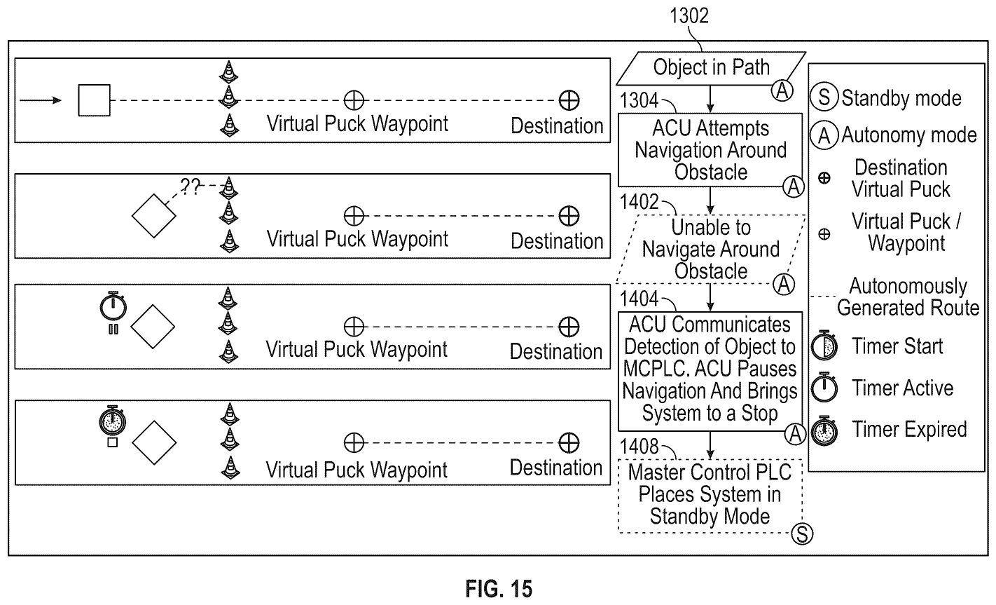

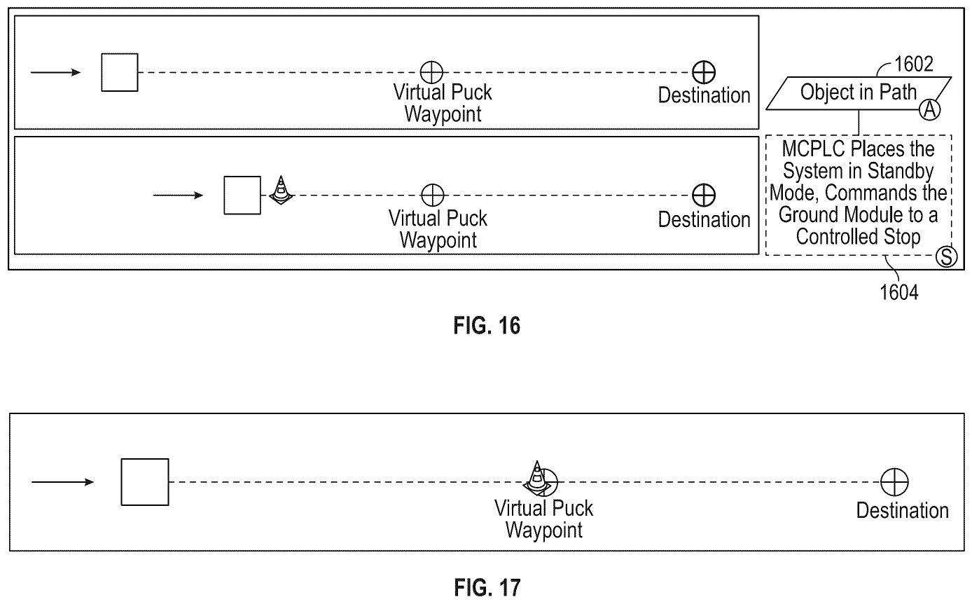

In some embodiments, as shown in FIG. 16, an object may enter the path of the ground module 101 during operation at step 1602. The master control PLC may place the system into standby mode and bring the system to a stop through commands to the ground module 101 at step 1604. In some embodiments, for example as shown in FIG. 17, an object may be blocking or in the way of a waypoint or destination. Objects may also appear unexpectedly during operation of the ground module 101 or may move into a previously clear path of the ground module 101. For example, a person may walk into the path of the ground module 101. The AGV system 100 may recognize that the obstacle is a person, and may start a timer for a configurable period. Upon an elapse of the configurable period or after the person exits the path of the ground module 101, the ACU may resume navigation to the next waypoint or destination.

In some instances, the AGV system 100 is configured to determine an object type of the obstacle and to use a stored configurable period corresponding to the object type of the object. In some instances, the AGV system 100 is configured to determine the object type of the obstacle by comparing image data captured by the telematics system 106 to stored training image data associated with a variety of different object types. In some instances, the configurable periods for each object type may be provided via a user input (e.g., a user may select different periods for different object types).

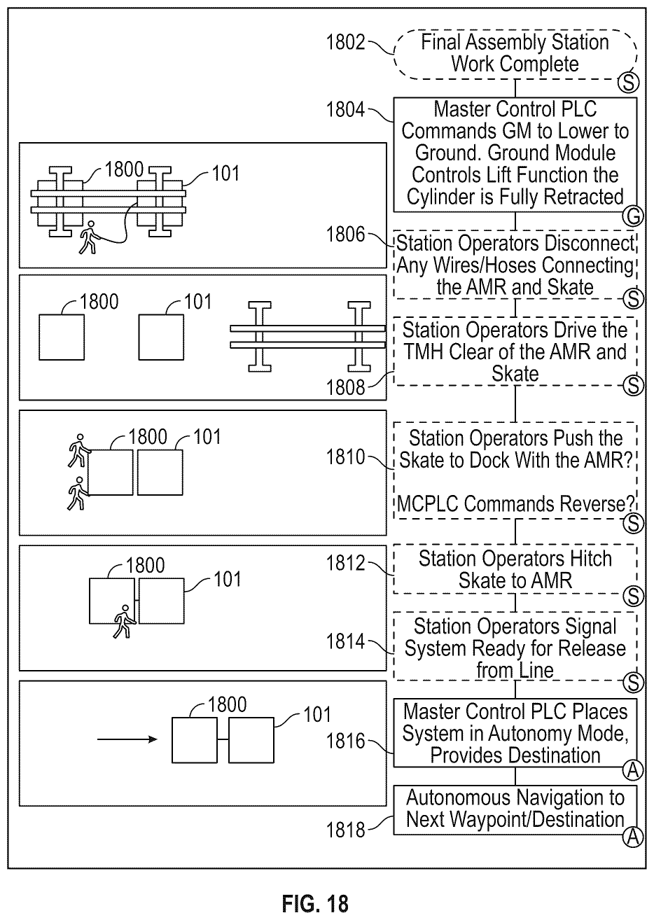

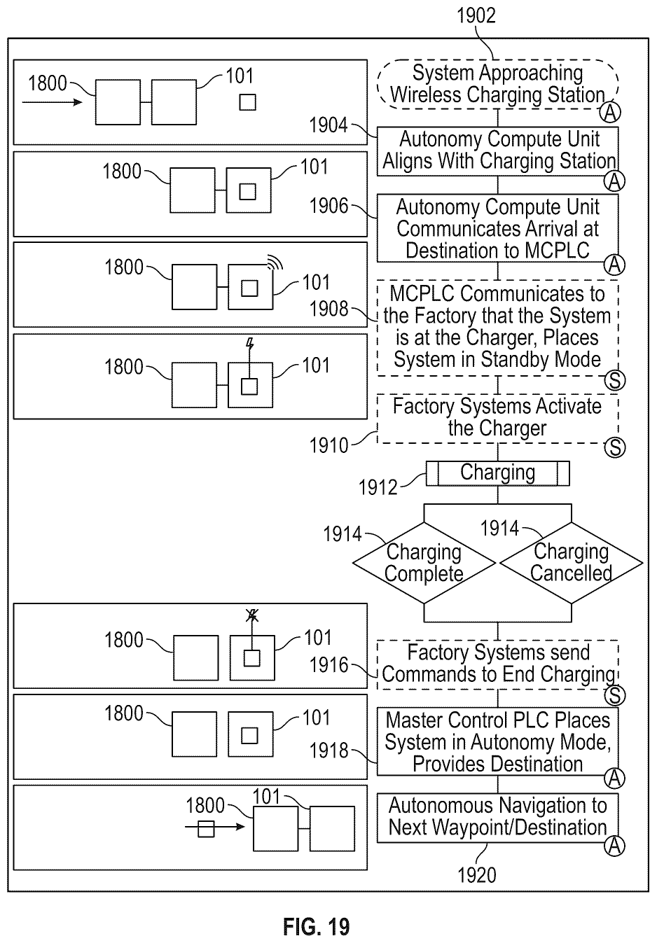

As shown in FIGS. 18 and 19, during main line mode, the ground module 101 may be working in tandem with a skate 1800 (e.g., a follower AMR, a non-powered dolly, etc.) and the start step may begin at a point where work has been completed at step 1802. Upon completion of work at a station (e.g., the final assembly station, etc.), station production line workers will communicate to the AGV system 100 that the work is complete.

If the station necessitates vertical motion (e.g., lowering of a load, etc.) of the WIP piece 110, the master control PLC will first place the system in Guided Mode. The master control PLC will then issue a target height via a message on the SCADA CAN network as a command to the ground module 101. The AGV system 100 controls the lift function of the ground module 101 until the target height is reached or the cylinder is fully retracted at step 1804. The station operators may be responsible for verifying overhead clearance during lift functions. The master control PLC and factory integration system 316 may be responsible for communicating impending and active motion visibly and audibly per regulatory standards and the production facility precedent.

Operators may disconnect hoses to prevent motion of the AGV system 100 at step 1806. The WIP piece 110 may be removed from the AGV system 100 by driving the WIP piece 110 forward, lifting or lowering the WIP piece 110, offloading the WIP piece 110, manual unloading of the AGV system 100, etc. until the WIP piece 110 is clear of the ground module 101 and the skate 1800 at step 1808. The ground module 101 of the AGV system 100 may be towed, moved, driven, unloaded, connected, etc. Operators may also push the skate 1800 to dock the skate 1800 of the AGV system 100 with the ground module 101 at step 1810 and hitch the skate 1800 to the ground module 101 at step 1812.

Operators may then signal to the production facility system 318 that the AGV system 100 is authorized to be released from the station at step 1814. The master control PLC and factory integration system 316 may be responsible for communicating the impending motion visibly and audibly per regulatory standards and production facility precedent. The master control PLC switches the AGV system 100 into Autonomy Mode and sends a destination target to the ACU via a message on the SCADA CAN network at step 1816. The message may provide the destination target. During autonomous navigation at step 1818, the ACU issues drive, speed, and steer angle requests to the ground module 101 via messages on the SCADA CAN network. When the AGV system 100 is in motion, the master control PLC and the factory integration system 316 are responsible for communicating the system state visibly and audibly per regulatory standards and production facility precedent.

As shown in FIG. 19, the AGV system 100 may dock at a charging station (e.g., a wireless charger, a secondary charger, etc.). The start step may begin at a point where the ground module 101 of the AGV system 100 is operating in Autonomy Mode as it approaches the charging station at step 1902. The autonomy system 304 identifies the charging station and issues drive and steer commands via messages on the SCADA CAN network as needed to the ground module 101 to sufficiently align a receiver pad with a charging pad at the charging station at step 1904. When the autonomy system 304 has achieved the goal of aligning the ground module 101 with the charging station, the autonomy system 304 communicates the alignment to the master control PLC via a message on the SCADA CAN network at step 1906. The master control PLC places the AGV system 100 in standby mode and communicates to the production facility system 318 that the AGV system 100 has arrived at the charging station and is ready to initiate charging at step 1908. The production facility 318 activates the charging station at step 1910, initiating charging of the onboard battery of the AGV system 100 at step 1912. During charging, drive functions of the AGV system 100 may be disabled. The length of time spent by the AGV system 100 charging may depend upon a strategy chosen by an operations team. The AGV system 100 may stay at the charging station until it is fully charged, may navigate from charging station to charging station in cadence with other line moves, or may be placed into a low power mode. After charging is complete or cancelled at step 1914, the production facility system 318 will issue a command to the charging station to discontinue charging at step 1916 and will communicate to the master control PLC that the AGV system 100 can move to the next destination.

The master control PLC and factory integration system 316 may be responsible for communicating the impending motion visibly and audibly per regulatory standards and production facility precedent. The master control PLC switches the AGV system 100 into Autonomy Mode and sends a destination target to the ACU via a message on the SCADA CAN network at step 1918. The message may provide the destination target. During autonomous navigation at step 1920, the ACU issues drive, speed, and steer angle requests to the ground module 101 via messages on the SCADA CAN network. When the AGV system 100 is in motion, the master control PLC and the factory integration system 316 are responsible for communicating the system state visibly and audibly per regulatory standards and production facility precedent.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus, system, assembly, etc. as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A method of guiding an autonomous guided vehicle (AGV), comprising:
determining, by one or more processors of the AGV, that a first work operation performed at a first assembly station on a work-in-progress (WIP) piece coupled to the AGV has been completed;
responsive to determining that the first work operation has been completed, switching, by the one or more processors, the AGV into an autonomy mode;
navigating, by the one or more processors, the AGV to a second assembly station;
determining, by the one or more processors, that the AGV has arrived at the second assembly station;
adjusting, by the one or more processors, the WIP piece to facilitate a second work operation to be performed at the second assembly station; and
switching, by the one or more processors, the AGV from the autonomy mode into a standby mode while the second work operation is performed on the WIP piece.

2. The method of claim 1, further comprising:
detecting, by the one or more processors, an obstacle in a path of the AGV;
plotting, by the one or more processors, a route for the autonomous guided vehicle around the obstacle; and
autonomously navigating, by the one or more processors, the AGV along the route.

3. The method of claim 1, further comprising:
detecting, by the one or more processors, an obstacle in a path of the AGV;
pausing, by the one or more processors, navigation of the AGV;
determining, by the one or more processors, that the obstacle has been removed from the path of the AGV; and
responsive to determining that the obstacle has been removed from the path of the AGV, resuming, by the one or more processors, navigation of the autonomous guided vehicle.

4. The method of claim 1, further comprising:
detecting, by the one or more processors, an obstacle in a path of the AGV;
pausing, by the one or more processors, navigation of the AGV;
determining, by the one or more processors, that a configurable time period associated with the obstacle has elapsed without the obstacle being removed from the path of the AGV; and
responsive to determining that the configurable time period has elapsed without the obstacle being removed from the path of the AGV, switching, by the one or more processors, the AGV into the standby mode.

5. The method of claim 4, further comprising:
subsequent to switching the AGV into the standby mode responsive to determining that the configurable time period has elapsed without the obstacle being removed from the path of the AGV, determining that the obstacle has been removed from the path of the AGV;
switching, by the one or more processors, the AGV into the autonomy mode; and
resuming, by the one or more processors, the navigation of the AGV.

6. The method of claim 1, further comprising aligning, by the one or more processors, the AGV with the second assembly station prior to switching the AGV from the autonomy mode into the standby mode.

7. The method of claim 1, further comprising aligning, by the one or more processors, the WIP piece to be at least one of received by or worked on at the second assembly station.

8. The method of claim 7, wherein aligning the WIP piece comprises:
determining, by the one or more processors, that vertical motion of the WIP piece is required;
responsive to determining that the vertical motion is required, switching, by the one or more processors, the autonomous guided vehicle into a guided mode; and
commanding, by the one or more processors, the AGV to perform a lift function until a target height is attained.

9. The method of claim 1, wherein autonomously navigating the AGV to the second assembly station comprises:
driving, by the one or more processors, the AGV along a route between sequential waypoints; and
upon arrival of the AGV at each waypoint, transmitting, by the one or more processors, a notification of arrival at the corresponding waypoint.

10. A method of guiding an autonomous guided vehicle (AGV), comprising:
navigating, by one or more processors of the AGV, the AGV in an autonomy mode along a path toward a destination;
detecting, by the one or more processors, an obstacle in the path;
determining, by the one or more processors, a characteristic of the obstacle;
performing, by the one or more processors, a response action for responding to the obstacle based at least in part on the characteristic of the obstacle; and
subsequent to performing the response action, continuing, by the one or more processors, navigation of the AGV to the destination.

11. The method of claim 10, wherein the characteristic of the obstacle comprises at least one of a size of the obstacle, a shape of the obstacle, a movement state of the obstacle, or whether the obstacle is a person.

12. The method of claim 10, wherein the response action comprises:
plotting, by the one or more processors, a route for the AGV around the obstacle; and
navigating, by the one or more processors, the AGV along the route.

13. The method of claim 10, wherein the response action comprises:
pausing, by the one or more processors, navigation of the AGV;
determining, by the one or more processors, that the obstacle has been removed from the path of the AGV; and
responsive to determining that the obstacle has been removed from the path of the AGV, resuming, by the one or more processors, navigation of the autonomous guided vehicle.

14. The method of claim 10, wherein the response action comprises:
pausing, by the one or more processors, navigation of the AGV;
determining, by the one or more processors, that a configurable time period associated with the obstacle has elapsed without the obstacle being removed from the path of the AGV; and
responsive to determining that the configurable time period has elapsed without the obstacle being removed from the path of the AGV, switching, by the one or more processors, the AGV into a standby mode.

15. The method of claim 14, wherein the configurable time period is based on the characteristic of the obstacle.

16. An autonomous guided vehicle (AGV) comprising:
a mobile platform configured to carry a work-in-progress (WIP) piece; and
a processing circuit having one or more processors coupled to one or more memories having instructions thereon that, when executed by the one or more processors, cause the one or more processors to:
navigate the AGV in an autonomy mode along a path toward an assembly station;
detect an obstacle in the path;
perform a response action for responding to the obstacle;
subsequent to performing the response action, continue navigation of the AGV toward the assembly station;
determine that the AGV has arrived at the assembly station; and
switch the AGV from the autonomy mode into a standby mode while a work operation is performed on the WIP piece.

17. The AGV of claim 16, wherein the instructions further cause the one or more processors to adjust the WIP piece to facilitate the work operation to be performed at the assembly station.

18. The AGV of claim 16, wherein the instructions further cause the one or more processors to determine a characteristic of the obstacle, and wherein the response action is performed based at least in part on the characteristic of the obstacle.

19. The AGV of claim 18, wherein the characteristic of the obstacle comprises at least one of a size of the obstacle, a shape of the obstacle, a movement state of the obstacle, or whether the obstacle is a person.

20. The AGV of claim 19, wherein the response action comprises:
pausing navigation of the AGV;
determining that a configurable time period corresponding to the characteristic of the obstacle has elapsed without the obstacle being removed from the path of the AGV; and
responsive to determining that the configurable time period has elapsed without the obstacle being removed from the path of the AGV, switching the AGV into the standby mode.
